(19) United States
(12) Patent Application Publication
(10) Pub. No.: US 2014/0233246 A1
(43) Pub. Date: Aug. 21, 2014

(54) PIVOTING THERMAL TRANSFER JOINT

(71) Applicants: Sebastien Lafreniere, Carignan (CA); Luc Monfette, Mercier (CA)

(72) Inventors: Sebastien Lafreniere, Carignan (CA); Luc Monfette, Mercier (CA)

(73) Assignee: KONINKLIJKE PHILIPS N.V., EINDHOVEN (NL)

(21) Appl. No.: 14/125,975

(22) PCT Filed: Jun. 12, 2012
(86) PCT No.: PCT/IB2012/052956

§ 371 Date: May 5, 2014

Related U.S. Application Data
(60) Provisional application No. 61/497,976, filed on Jun. 17, 2011.

(51) Int. Cl. F21V 29/00

(52) U.S. Cl. CPC F21V 29/267
USPC 362/364; 362/382

(57) ABSTRACT

A recessed luminaire thermal management assembly (20) includes a recessed luminaire can (22) having an open lower end (26) and an upper end (24) with at least one sidewall (28) extending between the open lower end and the closed upper end, an intermediate heat sink (50) connected to the luminaire can, the intermediate sink being rotatable through a horizontal plane, a source heat sink (70) being movable through a vertical plane, the source heat sink transferring heat to the luminaire can through the intermediate sink.

The present assemblies are directed generally to a pivoting joint for a luminaire. More particularly, various inventive methods and apparatuses disclosed herein relate to a multi-directional pivoting joint for a recessed luminaire configured for facilitating transfer of thermal energy.

### BACKGROUND

Recessed downlight, sometimes referred to as “can lights,” are light fixtures that are installed above ceiling elevation and shine light through an opening in a ceiling. When turned on, the luminaires appear to have light shining downwardly from above the ceiling level. These downlights typically concentrate light in either a narrow or a broad pattern and may be used to illuminate objects, areas or architectural details.

The fixtures utilize a frame, including a housing (sometimes referred to as a “can”), and a trim. The trim is a portion of the fixture that is at least partially below ceiling level which typically covers the opening in the ceiling wherein the fixture is positioned. The housing, and frame if utilized, are installed above the ceiling level and contain the lamp socket or holder as well as the lamp. The components within the housing are connected to a power supply to power the luminaire.

Typical recessed luminaires may come in insulation contact (“IC”) forms which are utilized when insulation will be in direct contact with the housing. Non-insulation contacts (“non-IC”) are used where there will be no contact with the insulation above the ceiling level. Non-IC fixtures are typically shallower than IC fixtures. These luminaires may also be utilized in remodeling situations or new constructions.

More recently, due to the cost and energy savings, lighting emitting diodes (LED) having been utilized to provide lighting in various types of fixtures. LED light sources contain the LED circuit board, which is driven by a driver typically installed adjacent the frame. These parts create the light output. However, light emitting diodes rely on thermal management techniques and structures to dissipate heat generated by the LED during operation. Maintaining a proper junction temperature is an important component to developing an efficient LED-based lighting system, as the LEDs perform with a higher efficacy when run at cooler temperatures. Conversely, when LED lights run at higher than normal temperatures; it not only lowers their efficiency but also reduces their life span and potentially makes the LEDs less reliable.

Thus, there is a need in the art to provide use of LED lights in the recessed luminaires in order to utilize their long life and high efficiency while also providing adjustability for aiming of the light being emitted therefrom. However, achieving this goal has been difficult due to the thermal management requirements of the LED luminaires.

### SUMMARY

The present disclosure is directed to inventive methods and apparatuses for providing a pivoting LED recessed luminaire which has appropriate structure for maintaining proper operating temperatures for long life of the LEDs and efficient operation. The apparatus utilizes a joint which provides for at least two degrees of freedom. That is, the luminaire may be adjusted to move about a vertical axis and about a horizontal axis. Despite this ability to move the luminaires to multiple positions desired by, for example a light designer, the joint also functions to remove heat created by the luminaires, for example LEDs.

Generally, in one aspect, a source sink is provided which is pivotable about one of a horizontal axis and a vertical axis. The source sink is most proximate the LED circuit board and is first to receive the heat created at the circuit board. A second intermediate sink is positioned in thermal communication with the source sink and receives heat transferred from the source sink. The second intermediate sink is movable about the other of a horizontal and vertical axis. The combination of movements of the two sinks provides for a highly adjustable joint which may be used to easily aim the light output from the luminaires. A third heat sink can is used to house the joint. The intermediate sink transfers heat to the heat sink can which in turn releases the heat to the environment. The can may have an open lower end, a substantially closed upper end and a sidewall there between which may incorporate a sidewall having a plurality of heat sink fins. The heat sinks may be formed of various materials and, in according to one embodiment, may be cast aluminum, although such material is exemplary and not limiting.

In some embodiments, the intermediate sink is rotatable about a vertical axis and through a horizontal plane. The intermediate sink may be suspended within the heat sink can and rotate therein. In some embodiments, the source heat sink is rotatable about a horizontal axis and through a vertical plane. According to one embodiment, the sinks may move in directions which are perpendicular to one another. The intermediate and source sinks each have at least one interface surface wherein thermal energy is transferred away from the luminaires and circuit board.

According to one embodiment, the pivoting joint may be used with an IC fixture. According to another embodiment, the pivoting joint may be used with a non-IC fixture. According to yet another embodiment the pivoting joint may be used with a remodeler fixture. Any of these embodiments may be used in new construction projects or in remodeling projects.

According to some embodiments, a fastener is spring biased and connects the source heat sink to the intermediate heat sink. In such embodiment, the fastener may be adjusted through a slide rail to move the source heat sink relative to the intermediate heat sink.

In some embodiments, the source heat sink and the intermediate heat sink have complimentary surfaces. These surfaces may be curved to allow movement of one sink relative to the other. The source heat sink, intermediate heat sink and the heat sink housing define a conduit for removal of thermal energy from an LED circuit board.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

The term “lighting fixture” or “luminaire” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates an upper perspective view of an embodiment of a recessed luminaire for a non-IC fixture.

FIG. 2 illustrates an exploded perspective view of a pivoting thermal management assembly of FIG. 1 for a recessed luminaire fixture of FIG. 1.

FIG. 3 illustrates an upper perspective view of a first vertical pivoting source heat sink.

FIG. 4 illustrates a lower perspective view of the first vertical pivoting source heat sink of FIG. 3.

FIG. 5 illustrates an upper perspective view of a second horizontal intermediate pivoting heat sink.

FIG. 6 illustrates a lower perspective view of the second horizontal intermediate pivoting heat sink of FIG. 5.

FIG. 7 illustrates a perspective view of the pivoting thermal management assembly of FIG. 2, with the luminaire can or heat sink housing removed.

FIG. 8 illustrates a side-section view of the pivoting thermal management assembly of FIG. 2.

FIG. 9 illustrates a lower perspective view of the pivoting thermal management assembly of FIG. 2.

FIG. 10 illustrates sectioned perspective view of the pivoting thermal management assembly of FIG. 2.

FIGS. 11-12 illustrate the pivoting thermal management assemblies utilized in alternative remodeler fixtures.

### DETAILED DESCRIPTION

Many lighting fixtures incorporating one or more LEDs for providing more efficient illumination are known. However, due to the need to maintain appropriate thermal transfer for efficient LED operation with longer life span, conventional LED-based fixtures have not utilized adjustment means available to make light aiming a possibility. Applicant has recognized and appreciated, however, a need in the art to provide a recessed downlight luminaire which is optically adjustable to aim the light in any of various desirable directions but which also maintains appropriate ability to dissipate heat, for longer life of the LEDs and improved efficiency.

In view of the foregoing, various embodiments and implementations of the present invention are directed to a pivotable thermal management assembly for a recessed downlight.

In the following detailed description, for purposes of explanation and not limitation, representative embodiments disclosing specific details are set forth in order to provide a thorough understanding of the claimed invention. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the claimed invention. For example, it is discussed that various embodiments of the pivoting thermal management assembly disclosed herein may be utilized in combination with recessed downlight luminaire fixtures to provide a luminaire which is adjustable in at least two directions and which further maintains heat transfer for thermal management. However, other structures and configurations incorporating movable structures and thermal conductors are contemplated without deviating from the scope or spirit of the claimed invention.

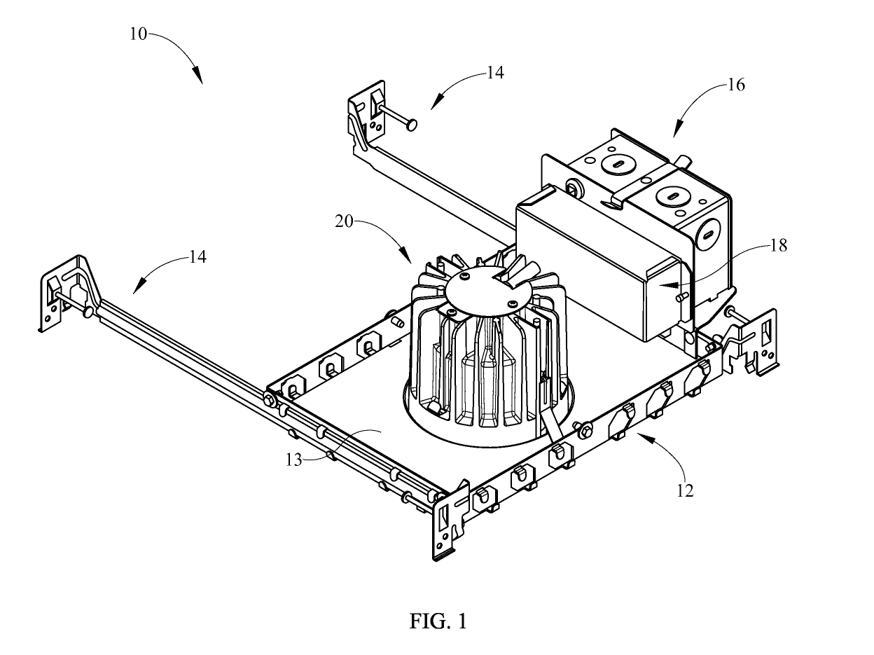

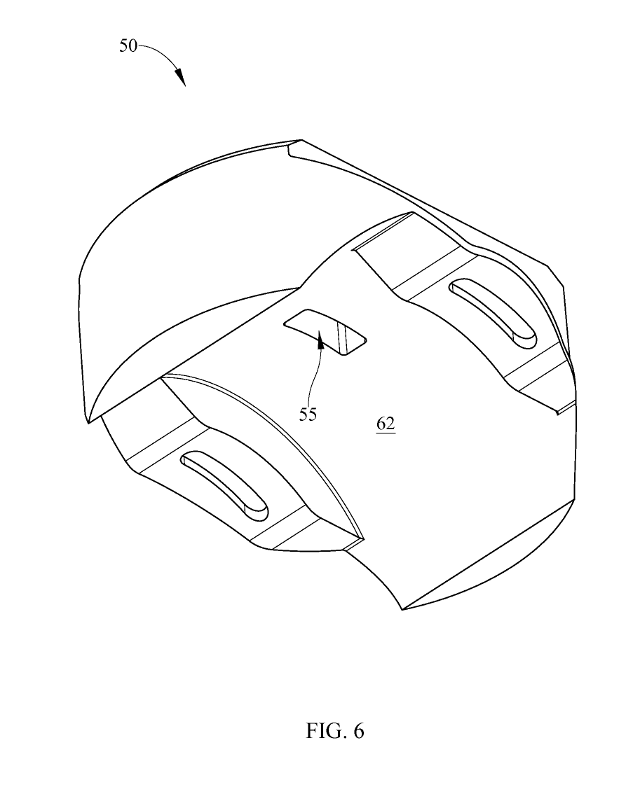

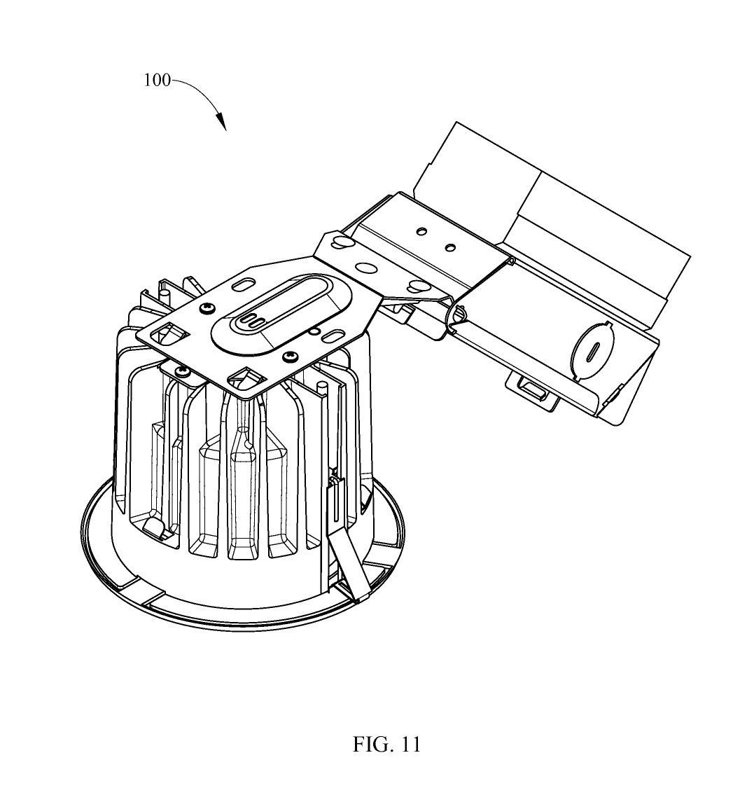

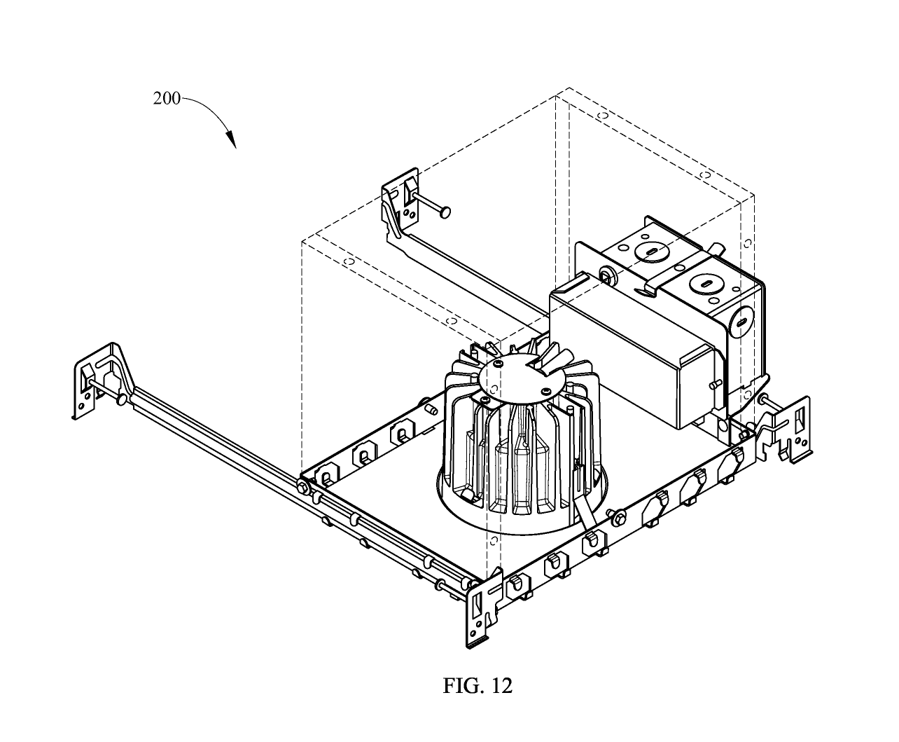

Referring to FIGS. 1 through 10, a first embodiment of a pivoting thermal management assembly for a recessed downlight is illustrated. This structure allows movement of an LED downlight into a variety of positions by moving about multiple axes. Moreover, the structure provides for heat transfer through the pivoting joint, which allows for improved transfer of thermal energy heretofore not available with LED luminaires. FIGS. 11 and 12 illustrate alternate luminaire fixtures which may be utilized with the device.

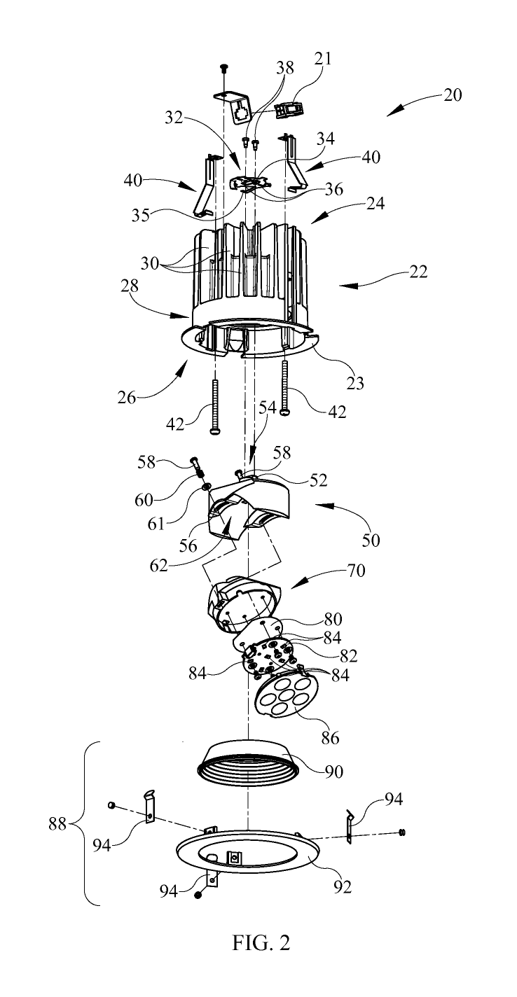

Referring initially to FIG. 1, a luminaire fixture 10 is shown in perspective view. The fixture comprises a frame 12 which in this instance is generally a flat pan with one or more vertical sides extending from edges of the pan 13. First and second opposed hanger bars 14 are positioned on opposite sides of the frame 12 for positioning the fixture 10 within suspended ceiling grid system or between ceiling joists or other structural members from which the system may depend above a ceiling or ceiling system. The hanger bars 14 may alternatively be moved to the other pair of opposed sides of the frame 12. The hanger bars 14 may be extendable or retractable to compensate for various lengths of joist spacing. Connected to the frame 12 is a junction box 16 and power supply or driver 18. The junction box 16 is connected to the power supply for the building where the fixture 10 is positioned and provides power to the power supply or driver 18 which in turn is provided to the luminaire for driving the luminaire or lamps 84 (FIG. 2). The driver 18 may include control and/or power wiring extending from the driver 18 to the thermal management assembly 20, which houses the luminaires. Wiring between the driver 18 and the pivoting thermal management assembly 20 is removed for clarity.

Positioned within the frame 12 is a pivoting thermal management assembly 20. This structure includes one or more luminaire LEDs 84 (FIG. 2) which are adjustable or pivotable in multiple directions and also provides the necessary thermal management or heat transfer capability necessary for proper operation of LED lamps while maintaining adjustability.

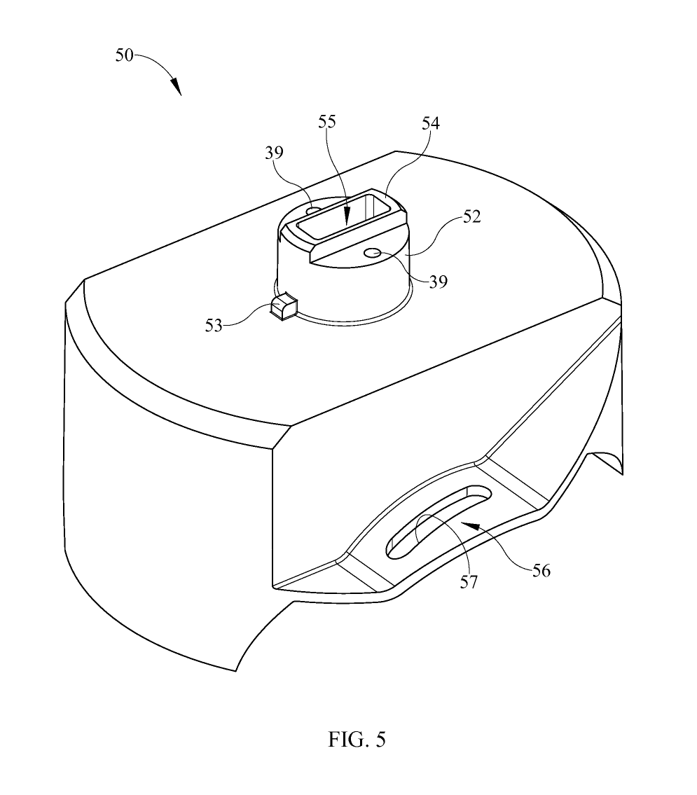

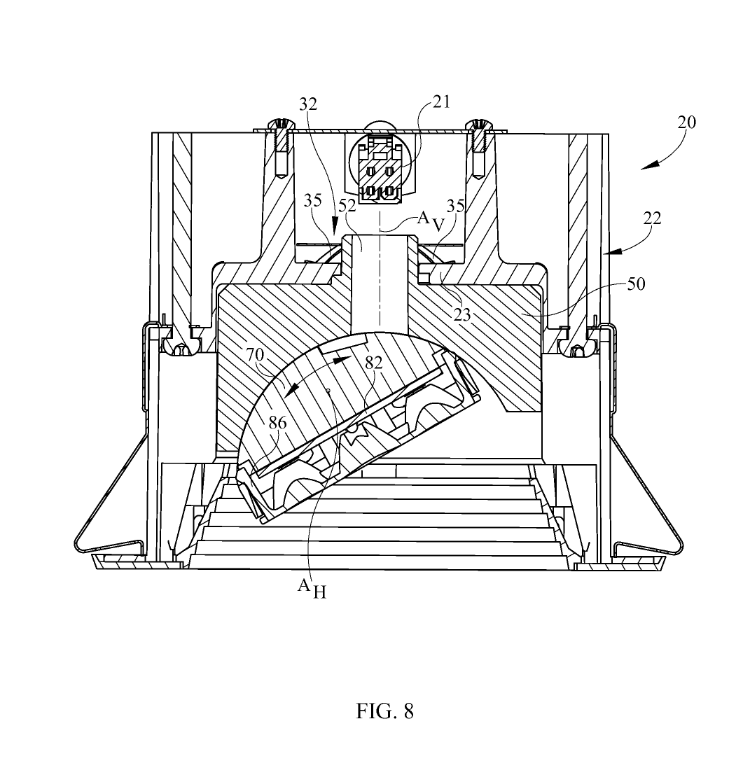

Referring now to FIGS. 2-6, an exploded perspective view of a pivoting thermal management assembly 20 is shown along with detail views of the parts forming the thermal management joint. The pivoting thermal management assembly 20 includes a heat sink can or housing 22. The housing 22 has a generally closed upper end 24 and an open lower end 26 with at least one sidewall 28 extending between the upper end 24 and the lower end 26. The sidewall 28 is generally defined by a plurality of heat sink fins 30. These fins provide added surface area for transferring thermal energy to air space surrounding the luminaire fixture 10. The can or housing 22 may be formed of cast aluminum or other metallic structures which have good thermal transfer characteristics are strong, lightweight and preferably easy to manufacture. The upper end 24 of the can 22 includes a recess which receives a spring 32. The spring 32 is utilized to capture an intermediate sink 50 described further herein. The spring 32 is seated on a surface of the can above the intermediate sink 50 to allow for movement, rotation or other translation of the intermediate sink 50 about a substantially vertical axis, as will be described further herein. The spring 32 includes an aperture 34 to capture the intermediate sink 50 as well as the first and second screws 38 through apertures 39 (FIG. 5) to connect the spring 32 to the intermediate sink 50 below the surface of the can 22. The can or housing 22 is generally closed meaning that the recess above spring 32 is closed with a cover or by the can 22. This limits contaminants from entering the recess area housing the spring 32 (FIG. 8) and inhibiting heat transfer or entering the recess area housing the spring 32 and inhibiting pivoting motion.

Exploded from the can 22 are elevation adjustment ceiling springs 40. These devices receive a screw 42 from the lower inside of the can 22 which passes through the can 22 and through the upper portion of each ceiling spring 40. By rotating the translation screws 42, each ceiling spring 40 can move up and down relative to the ceiling surrounding the can 22. This provides for easy adjustment of the can relative to the ceiling and tightening against the lower surface of the drywall of a lower lip 23.

Also positioned above the housing 22 is a connector 21 which is used to connect power and/or control wiring from the driver 18. This makes for quick, easy and reliable electrical connections between the driver 18 and the thermal management assembly 20.

Beneath the can 22 is an intermediate sink or horizontal pivot 50. The structure includes a pivot axle 52 extending upwardly from an upper surface of the structure. The pivot axle 52 includes a mating structure 54 which matches the aperture 34 in the horizontal rotation spring 32. The spring 32 is seated on a surface of the can 22 and the mating structure 54 passes through the aperture so that the intermediate sink or horizontal pivot 50 is retained against the lower surface of the topwall 23 of the can 22, defining an interface for thermal transfer, the upper surface of the topwall 23 being where the spring 32 is positioned. With the construction, the spring 32 can rotate with the horizontal pivot 50 within the can 22. This provides a rotation of the intermediate sink 50 at least partially through or within a substantially horizontal plane and about a substantially vertical axis extending through a pivoting thermal management assembly 20. The upper portion 54 and the axle 52 define a wireway 55 (FIGS. 5,6) which allows passage of wiring through pivot 50 to the source pivot 70. At the base of the axle 52 is a stop 53 (FIG. 5) which limits rotation of the pivot 50. The amount of rotation may be limited by various factors, including the size of the stop 53. The stop 53 of the instant embodiment limits rotation of the pivot 50 to about 358 degrees. This inhibits damage to wiring which would otherwise be caused by over-rotation of the pivot 50.

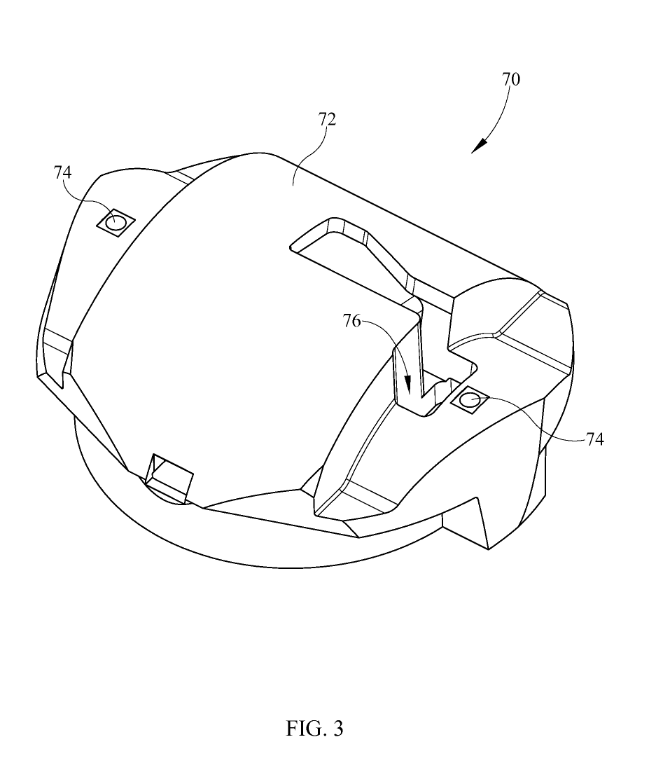

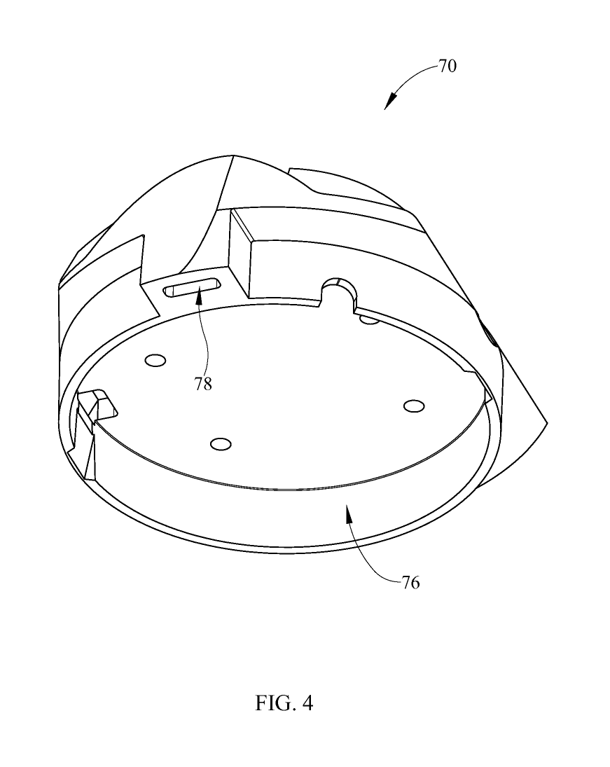

The horizontal pivot 50 further includes first and second slide rails 56 extending from the pivot 50. These rails may be of various forms but according to the instant embodiment include a slot 57 extending an arcuate distance to allow movement of a vertical pivot 70 through a vertical plane and about a horizontal axis. The rotation of the vertical pivot 70 may be through various preselected distances. The slide rails 56 receive screws 58 and a spring 60 and washer 61 against an upper surface thereof. The screws 58 are received in apertures 74 (FIG. 3) of the vertical pivot 70. The spring 60 provides a retaining force of the horizontal pivot 50 against the source heat sink or vertical pivot 70. The screws 58 and springs 60 maintain tension between the intermediate sink 50 and the first source heat sink or vertical pivot 70 while also allowing movement of the first heat sink or vertical pivot relative to the second heat sink or second intermediate heat sink or horizontal pivot 50. This source sink 70 may be rotated, moved and or otherwise translated by inserting a tool in the slot 78 (FIG. 4) to aim the light in a desirable direction. The lower portion of the horizontal pivot 50 includes a arcuate thermal transfer surface 62. The first vertical heat sink 70 moves at least partially through or within a substantially vertical plane and about a substantially horizontal axis when sliding against this arcuate thermal transfer 62. The thermal transfer surface 62 and complimentary arcuate surface 72 (FIG. 3) provide an arcuate thermal transfer interface where heat moves from the vertical pivot 70 to the horizontal pivot 50. Thus, the horizontal pivot 50 and vertical pivot 70 work in tandem to provide both substantially horizontal pivoting through a substantially horizontal plane, and substantially vertical pivoting through a substantially vertical plane. This allows for adjustment of the LED circuit board 82 in two perpendicular directions. However, due to the nature of the connections between the horizontal pivot 50 and the vertical pivot 70, heat created at the LED circuit board is passed through the source heat sink 70, through the intermediate sink 50 and to the can 22 for heat dissipation through the heat sink fins 30.

The source heat sink or vertical pivot 70 includes a curved or arcuate upper surface 72 (FIG. 3) which fits or mateably engages the arcuate thermal transfer surface 62. This allows the vertical pivot 70 to rotate relative to the horizontal pivot 70 about a horizontal axis. The screws 58 and springs 60 retain the intermediate sink 50 and the first sink 70 together without tightening in such manner that would inhibit adjustment or rotation of one part relative to the other. Beneath the source heat sink is a thermal transfer pad 80. This thermal transfer pad 80 may be formed of various materials, such as carbon graphite for example, and may be adhered to or used in combination with various thermal compounds or other forms of adhesive in order to ensure thermal communication with the vertical pivot 70. The vertical pivot 70 also includes a wireway 76 (FIG. 3) from which wiring is received from wireway 55 (FIGS. 5,6) and through which wiring passes to the circuit board 82 (FIG. 2).

Beneath the thermal transfer pad 80 is an LED circuit board 82 which is on a lower surface of the pad 80 and has a plurality of LEDs 84. Machine screws or other fasteners may be utilized to an extent through the circuit board 82 through a transfer pad 80 and to a first source heat sink 70 thereby retaining the structures together on the source heat sink or vertical pivot 70. Beneath the circuit board 82 is a lens refractor which may be utilized to vary the optics provided by the LEDs 84 on the circuit board 82. The lens refractor 86 may also be utilized with colored lenses or clear to provide to varying optics as desired.

Beneath the lens refractor 86 is a trim 88 which is partially seated within the can 22 when the structure or assembly 20 is assembled and partially disposed on the lower side of lip 23. The trim 88 includes a baffle or cone 90 and a flange 92. The baffle 90 may have various finishes including, for example, white or black and is stepped as shown. A cone may alternatively be smooth and have a clear, white, black or clear diffuse finish. Additionally, other colors may be utilized and although the trim 90 is shown with step structures, such trim may be smooth or may have other formations thereon. This may be determined by the light designer at the time of layout and design of the lighting system desired. For example, a non-exhaustive list of exemplary uses includes wall-washer, shield, glass (shower light), pin hole, drop glass, and others.

Beneath the baffle 90 is a flange 92 which seats along lip 23 of the can 22. This structure is seated on the bottom side of the ceiling and covers any aperture regularities in the ceiling which may be visible upon installation of the can 22 therein. The flange 92 includes multiple steel springs 94 which extend upward and engage with apertures of the can or housing 22 to retain the flange tightly against the can 22 and pull the flange upwardly against the ceiling. This upward pull of the flange 92 against the ceiling along with the down force created by the ceiling springs 40 ensure a tight closure of the luminaire against the ceiling and inhibit unintended light passage around the luminaire.

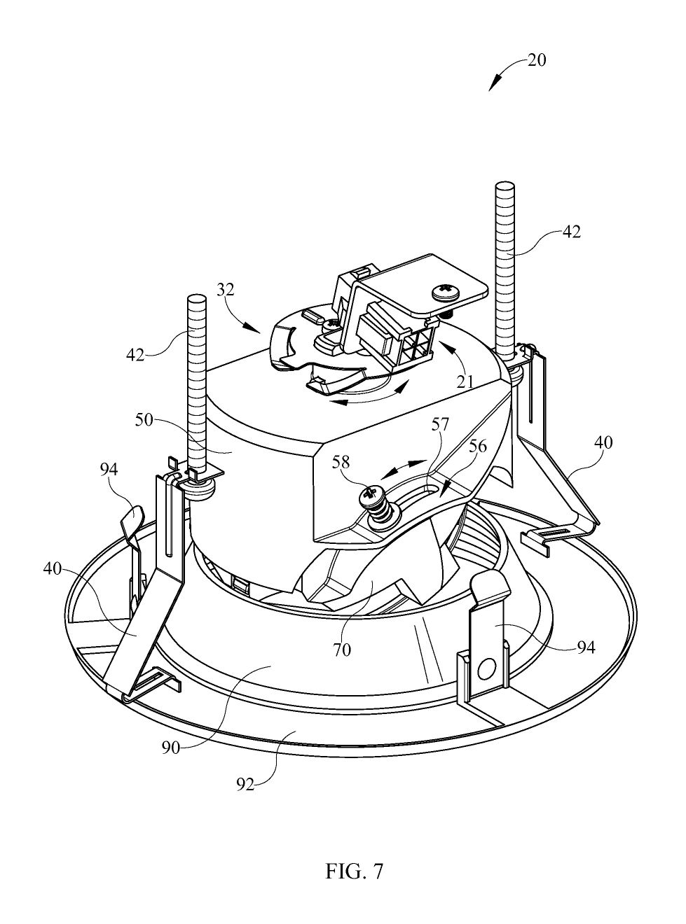

Referring now to FIG. 7, a perspective view of the assembled pivoting thermal management assembly 20 for a recessed luminaire is depicted with the heat sink can 22 removed for ease viewing the remainder of the assembly 20. At the lower end of the assembly 20, the flange 92 is positioned with the flange springs 94 extending upwardly therefrom. The flange springs 94 connect with the assembly 20 to retain the flange 92 with an upward force against the lower surface of the ceiling. Near the central portion of the flange 92, is the baffle or cone 90 which extends to near vertical pivot 70. Movement of the vertical pivot 70 provides motion about a horizontal axis. This movement combined with the pivoting about a vertical axis when the horizontal pivot 50 moves provide motion in two directions, which allows precise aiming of the light being emitted. A screwdriver or other tool may be used to adjust positioning through slot 78 (FIG. 4). The fasteners 58 move through the slide rail 56 backward and forward to provide the motion of the vertical pivot 70 about a horizontal axis. In the depicted position, the LED circuit board 82 (FIG. 2) is in a tilted position relative to the horizontal. When the fastener 58 is moved to the opposite end of the slide rail 56, the LED circuit board 82 moves to a horizontal position.

Referring now to FIG. 8, a side sectional view of the assembly 20 is depicted. The can 22 has a recessed upper surface upon which horizontal rotation spring 32 is seated. In this position, the spring 32 is disposed over an opening in the surface 23. Through this surface opening the axle 52 extends and the structure 54 passes through the spring 32 in frictional or other engagement or connection. Once engaged, the spring 32 places an upward biasing force on the horizontal pivot 50 so that the pivot 50 cannot move downwardly. The spring 32 has arms 35 which provide the upward biasing force on the pivot 50, once engaged. The pivot 50 alone or in combination the spring 32 can rotate about a vertical axis A_{V} providing one of the degrees of freedom of the joint assembly 20. Likewise, a point or dot represents a horizontal axis A_{H} about which the vertical pivot 70 rotates.

Between the pivot 50 and the pivot 70, a thermal interface is established. In this interface, one or more surfaces of the pivot 50 are in thermal communication with one or more surfaces of the pivot 70. These surfaces may or may not also be coated with thermal compound to enhance thermal transfer between the one or more adjacent surfaces. As a result, heat is transferred from the heat source, the LED circuit board 82, to the first heat sink 50, then to the intermediate heat sink 70 and on to the heat sink can 22. Heat may then be efficiently dissipated through the multiple heat sink fins 30.

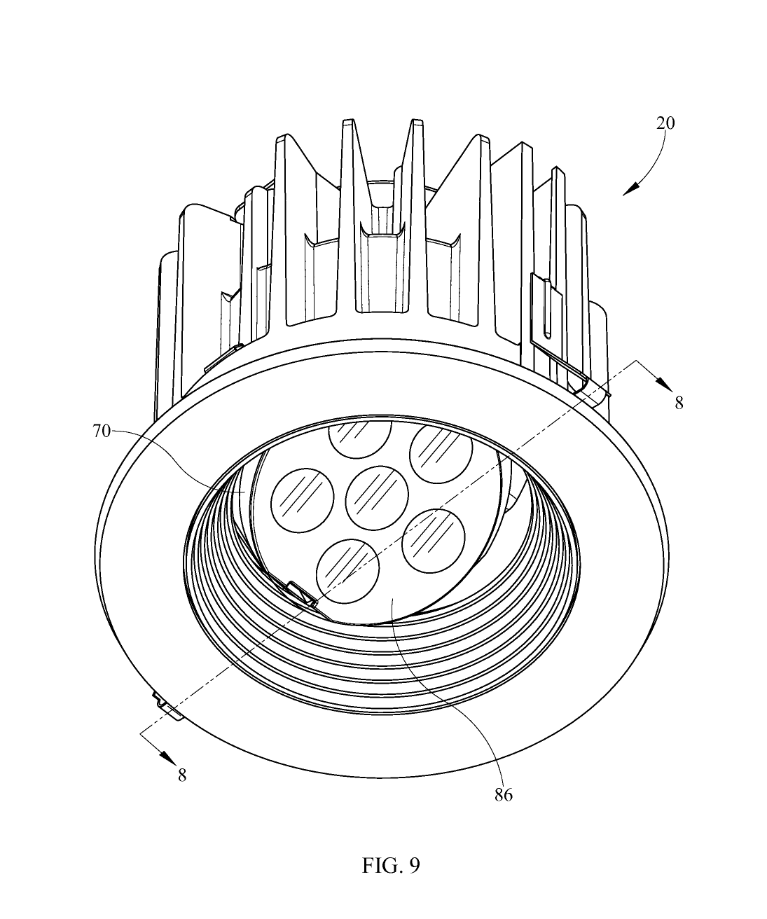

Referring now to FIG. 9, a lower perspective view of the thermal management system 20 is depicted. The Figure depicts that the lens refractor 86 is tilted at an angle to the horizontal. The vertical pivot 70 and the refractor 86 may alternatively be pivoted to a horizontal position or some position therebetween. However, as shown in the position depicted, with rotation about a vertical axis of the horizontal pivot 50, and the adjustability of the vertical pivot 70, the LEDs can be adjusted to a variety of positions for illuminating various objects, for example a wall wash or spot light in broad or focused light paths for illuminating art or architectural details.

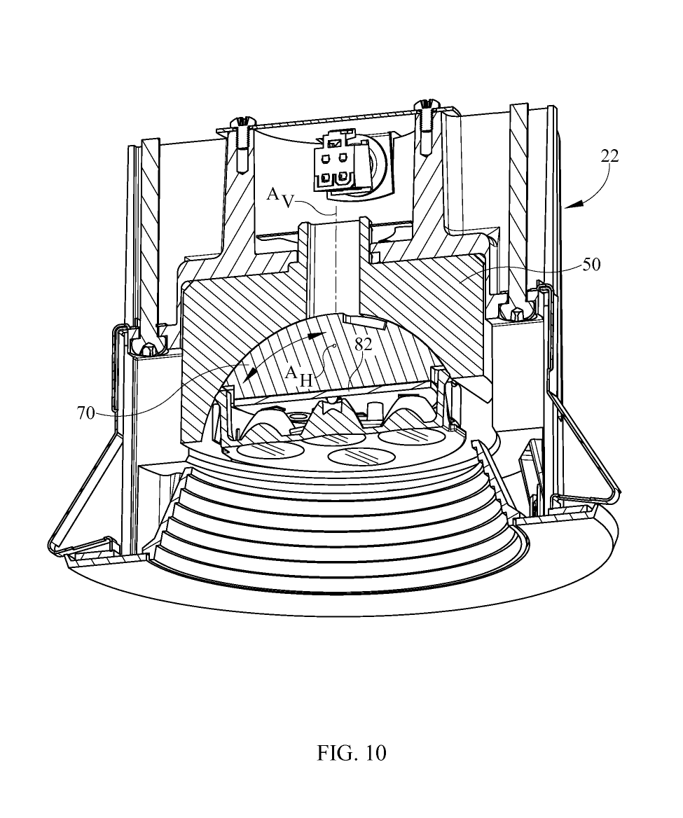

Referring to FIG. 10, the vertical pivot 70 is shown in the horizontal position for comparison with FIG. 8. One skilled in the art can also see that this joint allows for transfer of thermal energy from the vertical pivot 70 to the horizontal pivot 50 at the interface of the two parts 50,70. In turn the heat at the horizontal pivot 50 is transferred to the can 22. All of this occurs while allowing pivoting or motion of the LED circuit board 82 and LEDs thereon in at least two degrees of freedom.

With reference now to FIG. 11, a remodeler fixture 100 is depicted. The remodeler is meant for use in a ceiling with an existing aperture. Thus a large frame cannot be utilized through the ceiling opening. They fixture is built so that the thermal management assembly is solely used and may be positioned, with the power supply/driver and junction box, through the ceiling opening.

Alternatively, and with reference to FIG. 12, a fixture 200 is shown with for use having an IC frame. The pivoting thermal management assembly is positioned inside the IC frame housing allowing use in an insulated environment. The walls of the fixture frame are shown in broken line to view the pivoting thermal management assembly therein. It should be understood that the IC and non-IC fixtures may be used in new construction and remodels.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited. Also, reference numerals appearing in the claims in parentheses, are provided merely for convenience and should not be viewed as limiting in any way.

1. A recessed luminaire thermal management assembly, comprising:
a recessed luminaire heat sink housing having an open lower end and an upper end with at least one sidewall extending between said open lower end and said closed upper end;
an intermediate heat sink connected to said luminaire heat sink housing, said intermediate sink being movable at least partially within a substantially horizontal plane; and
a source heat sink being movable independently of said intermediate heatsink through a substantially vertical plane, said source heat sink transferring heat to said intermediate sink at one of a first arcuate thermal interface and through said intermediate heat sink to said luminaire heat sink housing at a second thermal interface.

2. The assembly of claim 1, wherein said source heat sink is connected to an LED circuit board.

3. The assembly of claim 1, further comprising a spring biased connection of said intermediate sink and said source sink.

4. The assembly of claim 1, wherein said source heat sink and said intermediate sink comprise a like material.

5. The assembly of claim 4, wherein said like material is cast aluminum.

6. The assembly of claim 4, wherein said heat sink housing is formed of cast aluminum.

7. The assembly of claim 1, wherein said intermediate and source sinks pivot in two different directions.

8. The assembly of claim 1 wherein said different directions are perpendicular to each other.

9. The assembly of claim 1 wherein said sidewall includes a plurality of heat sink fins.

10. A pivoting heat transfer assembly for a luminaire, comprising:
a heat sink can having an upper end, an open lower end and a plurality of fins;
a first spring structure connecting said heat sink can to an intermediate sink, said intermediate sink being rotatable about a substantially vertical axis;
a source heat sink being disposed against said intermediate heat sink, said source heat sink being movable independently of said intermediate heatsink about a substantially horizontal axis;
an LED circuit board connected to said source heat sink;
wherein said source heat sink transfers heat directly to said intermediate heat sink and said intermediate heat sink transfers heat directly to said heat sink can.

11. The assembly of claim 10, said luminaire being one of a remodeler, an I.C. luminaire or a non-I.C. luminaire.

12. The assembly of claim 10, said luminaire being an adjustable LED recessed luminaire.

13. The assembly of claim 10, further comprising a spring disposed between said intermediate heat sink and said source heat sink.

14. The assembly of claim 10, said heat sink can be adjustable relative to an upper surface of a ceiling.

15. The assembly of claim 10 further comprising a plurality of LEDs on said circuit board.

16. The assembly of claim 15, said LEDs being movable in two directions.

17. The assembly of claim 16, said movable source heat sink and intermediate sink defining a conduit to said can for thermal energy.

18. A pivoting thermal transfer assembly, comprising:
a first sink being movable in a first direction;
a second sink being movable in a second direction and connected to said first sink along an arcuate thermal transfer interface, said arcuate thermal transfer interface allowing transfer of thermal energy from one of said first sink to said second sink;
wherein said first direction is through a first plane and said second direction is through a second plane and further wherein said first direction and said second direction are substantially perpendicular;
a third sink being a heat sink can said can housing said first and second sinks.

19. The assembly of claim 19, further comprising a plurality of LED lamps in thermal communication with one of said first sink and said second sink.

20. The assembly of claim 19, wherein said first sink and said second sink define an adjustable joint.
